(19) United States
(12) Patent Application Publication
(10) Pub. No.: US 2008/0301730 A1
(43) Pub. Date: Dec. 4, 2008

(54) Method and device for TV channel search

(75) Inventor: Shuangxi Huang, Beijing (CN)

Correspondence Address: KINNEY & LANGE, P.A., THE KINNEY & LANGE BUILDING, 312 SOUTH THIRD STREET, MINNEAPOLIS, MN, 55415-1002, US

(73) Assignees: Legend Holdings Ltd., Beijing (CN); Lenovo (Beijing) Limited, Beijing (CN)

(21) Appl. No.: 12/154,361

(22) Filed: May 22, 2008

(30) Foreign Application Priority Data
May 29, 2007 (CN) 200710099735.4

(51) Int. Cl. H04N 5/445

(52) U.S. Cl. 725/38; 725/56; 348/732; 455/179.1

(57) ABSTRACT

A TV channel search method and device is provided, wherein the method comprises (a) snatching screenshots of real time video signals of frequencies to generate snatched screenshots; (b) establishing and storing correspondence relationship of the snatched screenshots and frequencies; (c) providing the snatched screenshots for user selection and obtaining a snatched screenshot selected by the user; and (d) obtaining a frequency corresponding to the snatched screenshot selected by the user based on the correspondence relation of the snatched screenshots and frequencies, and then performing aimed TV channel switch and play. According to the method and device of the invention, the user can quickly and visually search a TV channel independent on EPG information after the correspondence relationship of images and frequencies has been established by snatching screenshots of real time TV pictures, and the method and device is applicable in both analog TV and digital TV.

### BACKGROUND OF THE INVENTION

1. Field of Invention

The preset invention relates to a TV channel search technology and, in particular, a method and a device for searching a TV channel, which is applicable in an analogy TV and a digital TV, and independent on EPG (Electrical Program Guide) information.

2. Description of Prior Art

With the development of digital home concepts and schemes for applying those digital home concepts, applications such as TV playing and TV program recording have become important parts of digital home application schemes.

However, in modern TV programming, either analog or digital, the number of the channels is very large. For example, there are almost 80 channels of analog TV in some places, including satellite TVs and some local TV stations. For places having digital TV services, there are 500 or more channels of digital TV programs.

Due to so many channels and programs, an effective channel search means and method is needed for users when watching TV. Some solutions have been proposed in the art, such as internet electronic program guide (IEPG) service information based on analog TV and Teletext EPG based on digital TV.

Meanwhile, another solution has been disclosed by NXP Semiconductors, which is to set up a control system for users to conduct frame capture, and then associate the captured frame with a corresponding TV channel. This solution can only be used for digital TV and not analog TV. The convenience of this solution is low, as users need to manually trigger frame capture through a user control interface in this solution.

Therefore, a simple and new TV channel search solution is needed which is applicable in both digital TV and analog TV.

### SUMMARY OF THE INVENTION

An object of the present invention is to provide a TV channel search method and device, which can quickly and visually search and switch TV channels independent on EPG information, and is applicable in both digital TV and analog TV.

A TV channel search method is provided so as to achieve the above object which comprises:

Step 11 of snatching screenshots of real time video signals of frequencies to generate snatched screenshots;

Step 12 of establishing and storing correspondence relationship of the snatched screenshots and frequencies;

Step 13 of providing the snatched screenshots for user selection and obtaining a snatched screenshot selected by the user;

Step 14 of obtaining a frequency corresponding to the snatched screenshot selected by the user based on the correspondence relation of the snatched screenshots and frequencies, and then performing aimed TV channel switch and play.

The above method may also comprise:

Step 15 of snatching a screenshot of the pre-switching TV channel to generate a new snatched screenshot, and updating and storing correspondence relationship of the snatched screenshot of the pre-switching TV channel and the frequency, during channel switch.

In a particular embodiment of the method, in Step 13, the snatched screenshot selected by the user is a snatched screenshot the focus is located in.

In a particular embodiment of the method, particularly Step 11 comprises snatching a screenshot of real time video signals of a TV channel and generating a snatched screenshot at each frequency where a TV channel exists.

In a particular embodiment of the method, in step 11, a screenshot of real time video signals of a TV channel at a frequency where the TV channel exists is snatched to generate a snatched screenshot during channel search.

In a particular embodiment of the method, the frequencies are frequencies corresponding to a predetermined number of TV channels that the user recently watched.

In a particular embodiment of the method, the frequencies are frequencies corresponding to commonly-used TV channels selected by the user.

In a particular embodiment of the method, the frequencies are frequencies corresponding to a predetermined number of TV channels that the user watched for longest time.

A TV channel search device is provided so as to well achieve the above object which comprises:

a snatching module for snatching screenshots of real time video signals of frequencies to generate snatched screenshots;

a correspondence relationship storing module for establishing and storing correspondence relationship of the snatched screenshots and frequencies;

a snatched screenshot selection result obtaining module for providing the snatched screenshots for user selection and obtaining a snatched screenshot selected by the user;

a switch performing module for obtaining a frequency corresponding to the snatched screenshot selected by the user based on the correspondence relation of the snatched screenshots and frequencies, and then performing corresponding TV channel switch and play.

In a particular embodiment of the above device,

the snatching module also snatches a screenshot of the pre-switching TV channel to generate a new snatched screenshot during channel switch, and

the correspondence relationship storing module also updates and stores correspondence relationship of the snatched screenshot of the pre-switching TV channel and the frequency.

In a particular embodiment of the device, the snatched screenshot selected by the user is a snatched screenshot that the focus is located in.

In a particular embodiment of the device, the frequencies are frequencies corresponding to a predetermined number of TV channels that the user recently watched.

In a particular embodiment of the device, the frequencies are frequencies corresponding to commonly-used TV channels selected by the user.

In a particular embodiment of the device, the frequencies are frequencies corresponding to a predetermined number of TV channels that the user watched for longest time.

According to the method and device of the invention, the user can quickly and visually search a TV channel independent on EPG information after the correspondence relationship of images and frequencies has been established by snatching screenshots of real time TV picture, and the method and device is applicable in both analog TV and digital TV.

At the same time, the user is provided with various solutions such as multi-channel review based on preview pictures, commonly-used channel management based on preview pictures and audience rating ranking channel management based on preview pictures. All the preview pictures correspond to frequencies, and so the user is not required to manually trigger and thus the convenience is high.

### BRIEF DESCRIPTION OF THE DRAWINGS

FIG. 1 is a flow chart of the TV channel search method according to the present invention;

FIG. 2 is a diagram for the TV channel search device according to the present invention;

FIG. 3 is a flow chart of a first embodiment of the present invention;

FIG. 4 is a flow chart of a second embodiment of the present invention;

FIG. 5 is a flow chart of a third embodiment of the present invention;

FIG. 6 is a flow chart of a fourth embodiment of the present invention.

### DETAILED DESCRIPTION OF THE PRESENTLY PREFERRED EMBODIMENTS

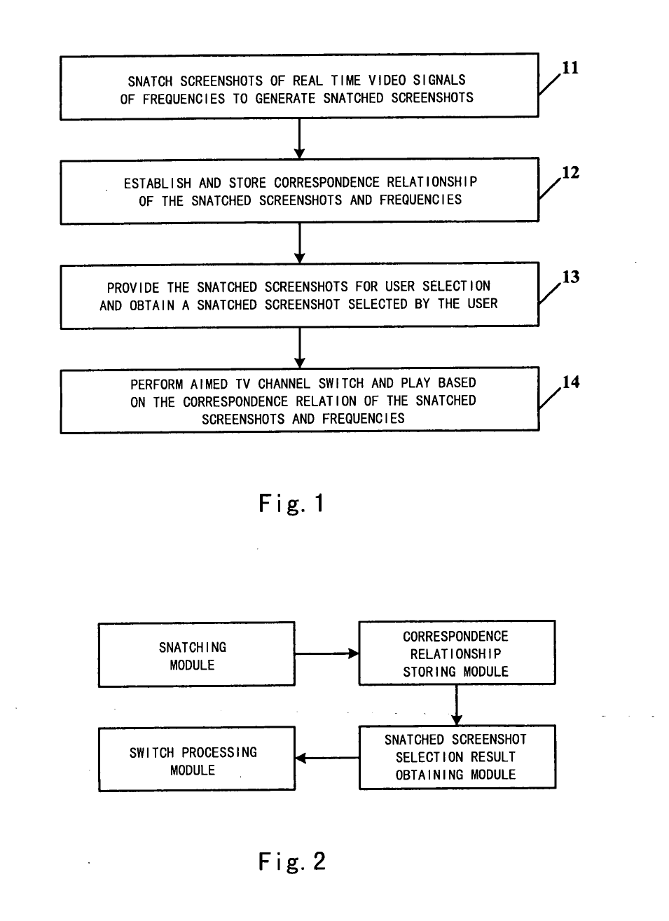

As shown in FIG. 1, the TV channel search method according to the invention comprises the steps of:

Step 11 of snatching screenshots of real time video signals of frequencies to generate snatched screenshots;

Step 12 of establishing and storing correspondence relationship of the snatched screenshots and frequencies;

Step 13 of providing the snatched screenshots for user selection and obtaining a snatched screenshot selected by the user;

Step 14 of obtaining a frequency corresponding to the snatched screenshot selected by the user based on the correspondence relation of the snatched screenshots and frequencies, and then performing aimed TV channel switch and play.

As shown in FIG. 2, the TV channel search device according to the invention comprises:

a snatching module for snatching screenshots of real time video signals of frequencies to generate snatched screenshots;

a correspondence relationship storing module for establishing and storing correspondence relationship of the snatched screenshots and frequencies;

a snatched screenshot selection result obtaining module for providing the snatched screenshots for user selection and obtaining a snatched screenshot selected by the user;

a switch performing module for obtaining a frequency corresponding to the snatched screenshot selected by the user based on the correspondence relationship of the snatched screenshots and frequencies, and then performing aimed TV channel switch and play.

Here so that the snatched screenshot can represent a program in real time, the method according to the invention also comprises:

Step 15 of the snatching module snatching a screenshot of the pre-switching TV channel to generate a new snatched screenshot, during the switch performing module performing channel switch;

Step 16 of the correspondence relationship storing module storing the snatched screenshot newly generated by the snatching module, and updating and storing the correspondence relationship of the snatched screenshot of the pre-switching TV channel and the frequency.

In the TV channel search device according to the invention, the snatching module also snatches a screenshot of the pre-switching TV channel to generate a new snatched screenshot during channel switch.

The correspondence relationship storing module also updates and stores the correspondence relationship of the snatched screenshot of the pre-switching TV channel and the frequency.

The snatch process of the invention is described as follow.

As to analog signals, a video signal stream is formed after the analog signals inputted through a signal tuner are subject to A/D conversion. And then a still screenshot, i.e. a snatched screenshot, is generated by automatically capturing the digital video signals.

As to digital signals which are of a standard MPEG stream, no conversion is required. A snatched screenshot can be generated by automatically capturing the digital video signals.

The frame snatching based on MPEG is a general technology which is described in detail in the MPEG2 specification, and thus the technology will not be described any more here.

### First Embodiment

In the first embodiment, the invention will be described in terms of common channel search.

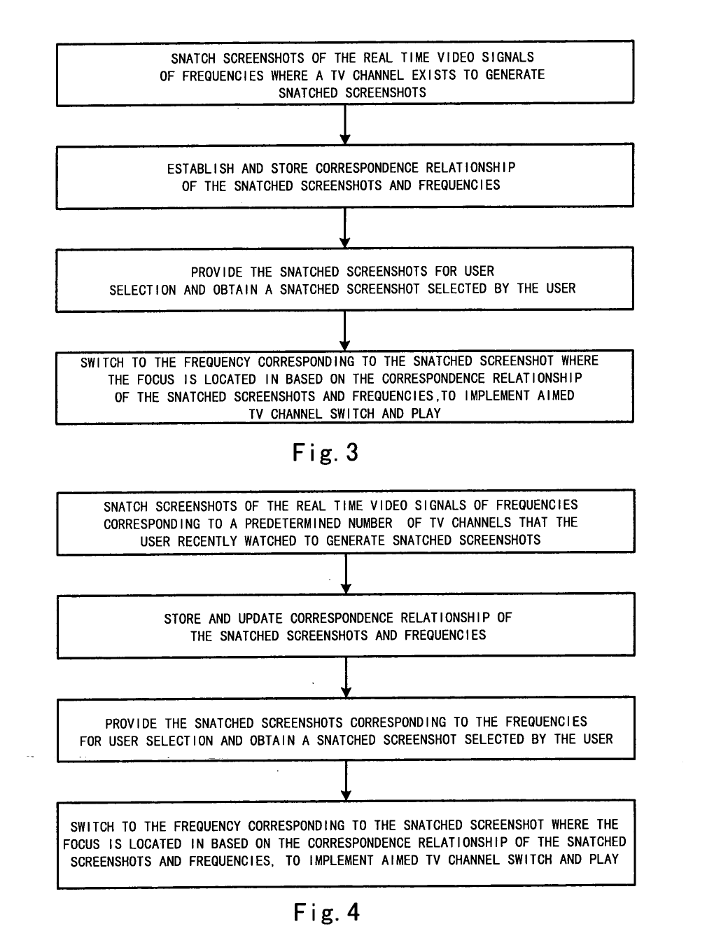

The first embodiment of the invention is shown in FIG. 3, and comprises

Step A1 of snatching screenshots of the real time video signals of frequencies where a TV channel exists to generate snatched screenshots; this step preferably is performed during TV channel search, that is to say:

During TV channel search, at each searched frequency where a TV channel exists, a screenshot of the real time video signals of the frequency is snatched to generate a snatched screenshot.

Step A2 of establishing and storing correspondence relationship of the snatched screenshots and frequencies;

Step A3 of providing the snatched screenshots for user selection and obtaining a snatched screenshot selected by the user; at this step, the snatched screenshot selected by the user is determined based on the position of the focus.

Step A4 of switching to the frequency corresponding to the snatched screenshot the focus is located in based on the correspondence relationship of the snatched screenshots and frequencies to implement aimed TV channel switch and play.

### Second Embodiment

When the user is watching a TV program and there are several channels that are playing programs that the user is interested in, the user will frequently switch between the several TV channels. In the second embodiment, the invention is described in terms of channel review.

In the second embodiment, the method of the invention is shown in FIG. 4, and particularly comprises:

Step B1 of snatching screenshots of the real time video signals of frequencies. corresponding to a predetermined number (larger than or equal to 3) of TV channels that the user recently watched to generate snatched screenshots;

Step B2 of storing and updating correspondence relationship of the snatched screenshots and frequencies;

Step B3 of providing the snatched screenshots corresponding to the frequencies for user selection and obtaining a snatched screenshot selected by the user;

Step B4 of switching to the frequency corresponding to the snatched screenshot the focus is located in based on the correspondence relationship of the snatched screenshots and frequencies to implement aimed TV channel switch and play.

If the frequencies corresponding to six TV channels that the user recently watched are frequency 1, frequency 2, . . . , frequency 6, respectively, then the snatched screenshots corresponding to the frequency 1, frequency 2 . . . frequency 6 are presented to the user to be selected when the user selects channel review, thus multi-channel review is implemented, and the user can switch between multiple channels in convenience.

### Third Embodiment

In the third embodiment, considering that the user usually watches some commonly-used TV channels, the invention will be described in terms of commonly-used TV channels.

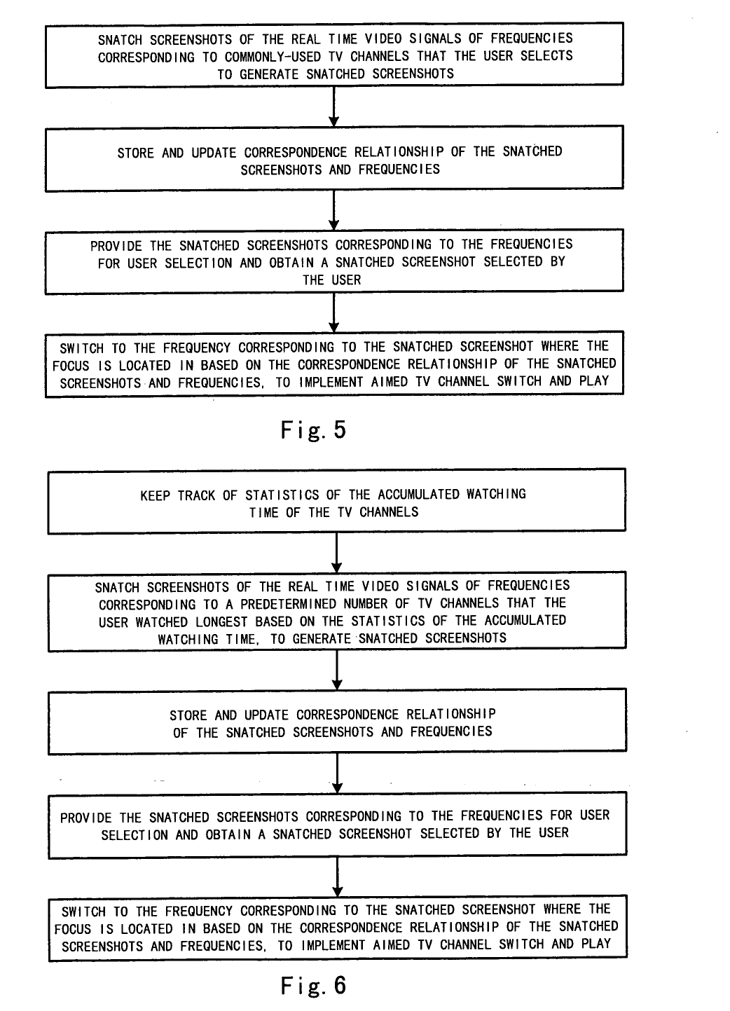

In the third embodiment, the method of the invention is shown in FIG. 5, and particularly comprises:

Step C1 of snatching screenshots of the real time video signals of frequencies corresponding to commonly-used TV channels that the user selects to generate snatched screenshots;

Step C2 of storing and updating correspondence relationship of the snatched screenshots and frequencies;

Step C3 of providing the snatched screenshots corresponding to the frequencies for user selection and obtaining a snatched screenshot selected by the user;

Step C4 of switching to the frequency corresponding to the snatched screenshot. the focus is located in based on the correspondence relationship of the snatched screenshots and frequencies to implement aimed TV channel switch and play.

If the frequencies corresponding to the commonly-used TV channels that the user selects are frequency 11, frequency 12 . . . frequency 16, respectively, then the snatched screenshots corresponding to frequency 11, frequency 12 . . . frequency 16 are presented to the user to be selected when the user selects commonly-used TV channels, thus a quick channel selection is implemented.

### Fourth Embodiment

In the fourth embodiment, the invention will be described in terms of channel watching time, in view of the case that the user has his/her preference, and the watching time of the interested TV channels will be longer, and the user often switches to his/her interested TV channels.

In the fourth embodiment, the method of the invention is shown in FIG. 6, and particularly comprises:

Step D1 of keeping track of statistics of the accumulated watching time of the TV channels;

Step D2 of snatching screenshots of the real time video signals of frequencies corresponding to a predetermined number of TV channels that the user watched longest based on the statistics of the accumulated watching time, to generate snatched screenshots;

Step D3 of storing and updating correspondence relationship of the snatched screenshots and frequencies;

Step D4 of providing the snatched screenshots corresponding to the frequencies for user selection and obtaining a snatched screenshot selected by the user;

Step D5 of switching to the frequency corresponding to the snatched screenshot the focus is located in based on the correspondence relationship of the snatched screenshots and frequencies to implement aimed TV channel switch and play.

The device according to the embodiment of the invention also comprises: a statistics module for keeping track of statistics of the accumulated watching time of the TV channels; and

the snatching module snatches screenshots of the real time video signals of frequencies corresponding to a predetermined number of TV channels that the user watched longest based on the statistics of the accumulated watching time, to generate snatched screenshots.

If the frequencies corresponding to the TV channel that the user watched longest in a period are frequency 31, frequency 32 . . . frequency 36, then the snatched screenshots corresponding to frequency 31, frequency 32, . . . , frequency 36 are presented to the user to be selected when the user selects commonly-used TV channel, and thus a quick channel selection is implemented. The user can switch between channels quickly to watch his/her interested TV program.

Although the present invention has been described with reference to the specific embodiment, those skilled in the art will recognize that changes and variations may be made without departing from the spirit and the scope of the invention, which are defined by the appended claims.

1. A TV channel search method, comprising:
(a) snatching screenshots of real time video signals of frequencies to generate snatched screenshots;
(b) establishing and storing correspondence relationship relationships of the snatched screenshots and frequencies;
(c) providing the snatched screenshots for user selection and obtaining a snatched screenshot selected by the user; and
obtaining a frequency corresponding to the snatched screenshot selected by the user based on the correspondence relation of the snatched screenshots and frequencies, and then performing aimed TV channel switch and play.

2. The method according to claim 1, further comprising:
(e) snatching a screenshot of a pre-switching TV channel to generate a new snatched screenshot, and updating and storing a correspondence relationship of the snatched screenshot of the pre-switching TV channel and the frequency, during channel switch.

3. The method according to claim 1, wherein in Step (c), the snatched screenshot selected by the user is a snatched screenshot a focus is located in.

4. The method according to claim 1, wherein Step (a) comprises snatching a screenshot of real time video signals of a TV channel and generating a snatched screenshot at each frequency where a TV channel exists during channel search.

5. The method according to claim 4, wherein in step (a), a screenshot of real time video signals of a TV channel at a frequency where the TV channel exists is snatched to generate a snatched screenshot during channel search.

6. The method according to claim 1, wherein the frequencies are frequencies corresponding to a predetermined number of TV channels that the user recently watched.

7. The method according to claim 1, wherein the frequencies are frequencies corresponding to commonly-used TV channels selected by the user.

8. The method according to claim 1, wherein the frequencies are frequencies corresponding to a predetermined number of TV channels that the user watched for longest time.

9. A TV channel search device, comprising:
a snatching module for snatching screenshots of real time video signals of frequencies to generate snatched screenshots;
a correspondence relationship storing module for establishing and storing correspondence relationship of the snatched screenshots and frequencies;
a snatched screenshot selection result obtaining module for providing the snatched screenshots for user selection and obtaining a snatched screenshot selected by the user; and
a switch performing module for obtaining a frequency corresponding to the snatched screenshot selected by the user based on the correspondence relation of the snatched screenshots and frequencies, and then performing corresponding TV channel switch and play.

10. The device according to claim 9, wherein:
the snatching module also snatches a screenshot of a pre-switching TV channel to generate a new snatched screenshot during channel switch, and
the correspondence relationship storing module also updates and stores correspondence relationship of the snatched screenshot of the pre-switching TV channel and the frequency.

11. The device according to claim 9, wherein the snatched screenshot selected by the user is a snatched screenshot that a focus is located in.

12. The device according to claim 9, wherein the frequencies are frequencies corresponding to a predetermined number of TV channels that the user recently watched.

13. The device according to claim 9, wherein the frequencies are frequencies corresponding to commonly-used TV channels selected by the user.

14. The device according to claim 9, further comprising
a statistics module for keeping track of statistics of the accumulated watching time of the TV channels; and
the frequencies are frequencies corresponding to a predetermined number of TV channels that the user watched for longest time which are determined based on the statistics result.
